(19) United States
(12) Patent Application Publication
(10) Pub. No.: US 2017/0138800 A1
(43) Pub. Date: May 18, 2017

(54) TEMPERATURE SENSOR

(71) Applicant: TOKYO ELECTRON LIMITED, Tokyo (JP)

(72) Inventors: Masatoshi TABIRA, Hyogo (JP); Masahisa SUGIHARA, Hyogo (JP); Yuji MIZUMA, Hyogo (JP); Takari YAMAMOTO, Tokyo (JP)

(73) Assignee: TOKYO ELECTRON LIMITED, Tokyo (JP)

(21) Appl. No.: 15/325,525

(22) PCT Filed: Jul. 14, 2014
(86) PCT No.: PCT/JP2014/003715

§ 371 Date: Jan. 11, 2017

(51) Int. Cl. G01K 11/00; G01K 1/08

(52) U.S. Cl. CPC G01K 11/00; G01K 1/08

(57) ABSTRACT

A temperature sensor includes a sensing member, a retention member configured to secure the sensing member, an optical fiber configured to irradiate the sensing member with light and guide the light reflected from the sensing member, and a cylindrical sleeve configured to accommodate the optical fiber. The retention member is a plate-shaped component and has a cut-out portion formed on at least one of a peripheral portion of a non-retention surface of the retention member opposite to a retention surface to which the sensing member is secured and a side surface of the retention member. The retention member is secured to a tip of the sleeve so that the non-retention surface is exposed to the outside, and the tip of the sleeve is engaged with the cut-out portion.

### FIELD OF THE INVENTION

The present invention relates to a temperature sensor; and more particularly, to an optical temperature sensor using an optical fiber.

### BACKGROUND OF THE INVENTION

There are many types of temperature sensors, and a temperature sensor is appropriately selected among them depending on a purpose or a place of usage. For example, as disclosed in Patent Document 1, an optical temperature sensor may be used when it is undesirable to allow electric current to flow in a measurement location.

The temperature sensor disclosed in Patent Document 1 measures a body temperature and thus is configured as an optical temperature sensor capable of preventing an electric shock to a body. Further, since this temperature sensor is used to measure temperature in the body for medical purposes, a transducer is made by combining two kinds of polymers suitable for measurement of a temperature close to a room temperature.

Patent Document 1: Japanese Patent Application Publication No. H06-213732

However, the temperature sensor disclosed in Patent Document 1 cannot measure a temperature of 100° C. or above due to the property of the polymer. It is necessary to measure a temperature of 100° C. or above when measuring temperatures of a plasma processing apparatus and a processing target thereof, for example. In the processing of the plasma processing apparatus, a plasma state is disturbed when employing a temperature sensor using electric current. Therefore, it is required to measure a temperature by using an optical temperature sensor.

As for the optical temperature sensor for measuring a high temperature, there may be used a sensor using a semiconductor as a transducer, a sensor that utilizes a change in the color of liquid crystals, and a sensor that utilizes a change in the intensity of a fluorescent material, which are disclosed in background of the invention of Patent Document 1. However, all of the above temperature sensors need to be manufactured at a low cost without variation of characteristics. Thus, the productivity of the conventional optical temperature sensor needs to be improved.

### SUMMARY OF THE INVENTION

In view of the above, the present invention provides a temperature sensor that can be manufactured at a low cost without variation.

In accordance with an embodiment of the present invention, there is provided a temperature sensor including: a sensing member; a retention member configured to fixedly secure the sensing member; an optical fiber configured to irradiate the sensing member with light and guide the light reflected from the sensing member; and a cylindrical sleeve configured to accommodate the optical fiber. The retention member is a plate-shaped component and has a cut-out portion formed on at least one of a peripheral portion of a non-retention surface of the retention member opposite to a retention surface of the retention member to which the sensing member is fixedly secured and a side surface of the retention member. The retention member is secured to a tip of the sleeve so that the non-retention surface is exposed to an outside, and the tip of the sleeve is engaged with the cut-out portion. The sensing member of the temperature sensor is a member that contains a material having temperature-dependent physical properties. Temperature measurement is performed by measuring the physical properties and converting the measured physical properties to a temperature.

Further, the retention member may be made of a metal and the sleeve is made of super engineering plastic. The super engineering plastic has heat resistance of 150° C. or above, strength of 49 MPa or above, and an elastic bending modulus of 2.4 GPa or above. Specifically, the super engineering plastic may include polysulfone (PSF), polyarylate (PAR), polyetherimide (PEI), polyimide (PI), polyetheretherketone (PEEK), polyphenylenesulfide (PPS), polyethersulfone (PES), polyamideimide (PAI), liquid crystal polymer (LCP), fluorine resin, or the like. Further, the retention member may be made of aluminum and the sleeve may be made of polyphenylene sulfide.

Further, a cut-off portion that allows communication between an inner space and an outer space of the sleeve may be formed at the tip of the sleeve.

### Effect of the Invention

In the temperature sensor of the present invention, the cut-out portion is provided on at least one of the side surface and the peripheral portion of the retention member for fixedly securing the sensing member, and the tip of the sleeve is engaged with the cut-out portion. Therefore, the retention member can be readily and firmly secured to the sleeve and, further, the temperature sensor can be manufactured at a low cost.

### BRIEF DESCRIPTION OF THE DRAWINGS

FIG. 1A is a schematic top view of main parts of a temperature sensor according to a first embodiment and FIG. 1B is a schematic cross sectional view taken along line A-A.

FIGS. 2A and 2B are schematic cross sectional views of a leading end portion of the temperature sensor according to the first embodiment.

FIG. 3 is a schematic cross sectional view of the temperature sensor according to the first embodiment.

FIG. 4 is a schematic cross sectional view of main parts of a temperature sensor according to a second embodiment.

FIG. 5 is a schematic cross sectional view of a leading end portion of the temperature sensor according to the second embodiment.

FIG. 6 is a schematic cross sectional view of main parts of a temperature sensor according to a third embodiment.

FIG. 7 is a schematic cross sectional view of a leading end portion of the temperature sensor according to the third embodiment.

FIG. 8 is a schematic cross sectional view of main parts of a temperature sensor according to a fourth embodiment.

FIG. 9 is a schematic cross, sectional view of a leading end portion of the temperature sensor according to the fourth embodiment.

FIG. 10 is a schematic cross sectional view of main parts of a temperature sensor according to a comparative′ example.

FIG. 11 is a schematic cross sectional view of a leading end portion of the temperature sensor according to the comparative example.

FIG. 12 is a schematic top view of a leading end portion of a temperature sensor according to a fifth embodiment.

### DETAILED DESCRIPTION OF THE EMBODIMENTS

Hereinafter, circumstances that have led to the present invention will be described before the description of the embodiments of the present invention.

In a temperature sensor using a semiconductor as a transducer, a temperature sensor that utilizes a change in the color of liquid crystals, a temperature sensor that utilizes a principle in which spectral distribution or lifetime of solid photoluminescence (fluorescence or phosphorescence) changes depending on a temperature, or the like, a sensing member, which converts temperature changes into changes in another physical property, is protected to prevent breakage thereof and to prevent temperature characteristics of the sensing member from being deteriorated or changed. For example, a sensing member and an optical fiber are provided in a sealed space to measure changes in a physical property. In this case, it is general that the sensing member is secured to a retention member; the optical fiber is inserted into a sleeve; and the retention member is secured to a tip of the sleeve. Further, the sensing member is arranged in an inner space of the sleeve to face the optical fiber.

For example, a sensing member 10 is secured to one surface (mounting surface 39a) of a circular plate-shaped retention member 39 by an adhesive 20 as shown in FIG. 10 and the retention member 39 is secured to a tip of a sleeve 90 by an adhesive 22 as shown in FIG. 11. Due to demand for a miniaturization of the temperature sensor, the retention member 39 has a diameter of about 3 mm. In this case, a temperature measurement surface 39b (opposite to the mounting surface 39a) of the retention member 39 is brought into contact with a measurement target or provided in a measurement target space, so that the temperature of the temperature measurement surface 39b becomes the same as that of the measurement target by heat transfer. Further, this heat transfer is continued to the adhesive 20 and then to the sensing member 10 so that the adhesive 20 and the sensing member 10 successively have the same temperature as the measurement target to thereby perform the temperature measurement.

In the structure shown in FIG. 11, the retention member 39 is secured to the sleeve 90 by the adhesive 22. However, in this structure, the adhesion area is small since only a part of the side surface of the retention member 39 and an extremely small part of a periphery of the mounting surface 39a are used for the adhesion between the retention member 39 and the sleeve 90. Thus, it is difficult to always firmly secure the retention member 39 to the sleeve 90. Further, it is required to uniformly coat the appropriate amount of the adhesive 22 onto the inner periphery of the sleeve 90 to prevent the adhesive 22 from protruding beyond the tip of the sleeve 90 having a diameter of 3 mm and it is also required to fit the retention member into the tip of the sleeve 90 without generating inclination of the retention member 39. However, these works are very difficult since the adhesion surfaces are small. Therefore, a securing strength between the sleeve 90 and the retention member 39, a protruding amount of the adhesive 22, and a degree of inclination of the retention member 39 are different for each temperature sensor. Accordingly, sensor characteristics such as responsiveness characteristics with respect to temperature changes vary depending on the temperature sensors.

Further, it requires tremendous efforts to fit and adhere the retention member 39 having a diameter of 3 mm or less to the tip of the sleeve 90 without generating inclination of the retention member 39. Therefore, a manufacturing cost is increased.

The present inventors have performed various examinations to solve the above-described drawbacks and have achieved the present invention. Hereinafter, embodiments of the present invention will be described in detail with reference to the accompanying drawings. For the sake of simple description, like reference numerals will be given to like parts having the substantially same functions in the following drawings.

### First Embodiment

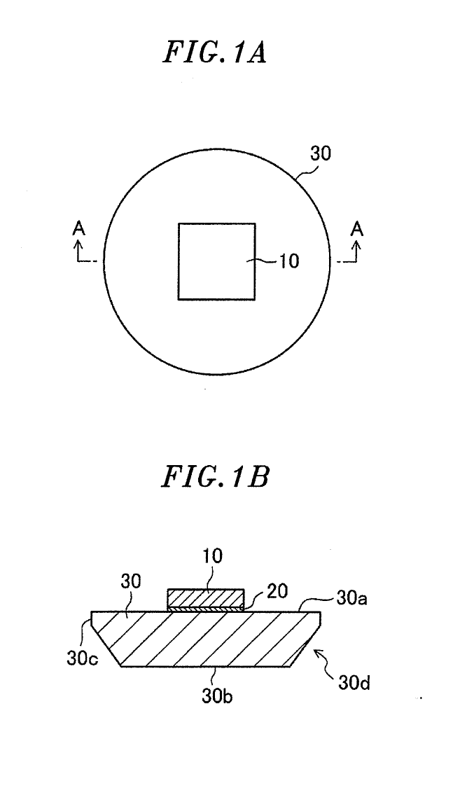

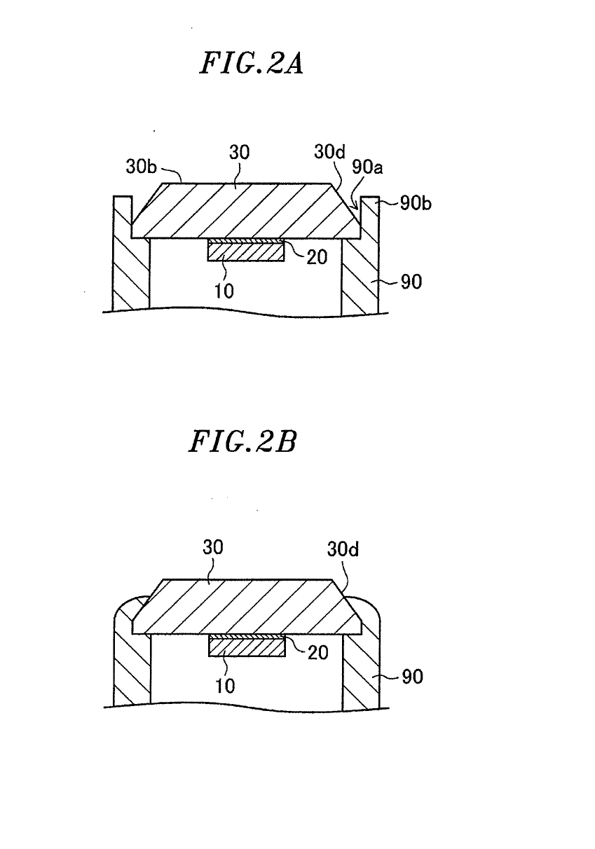

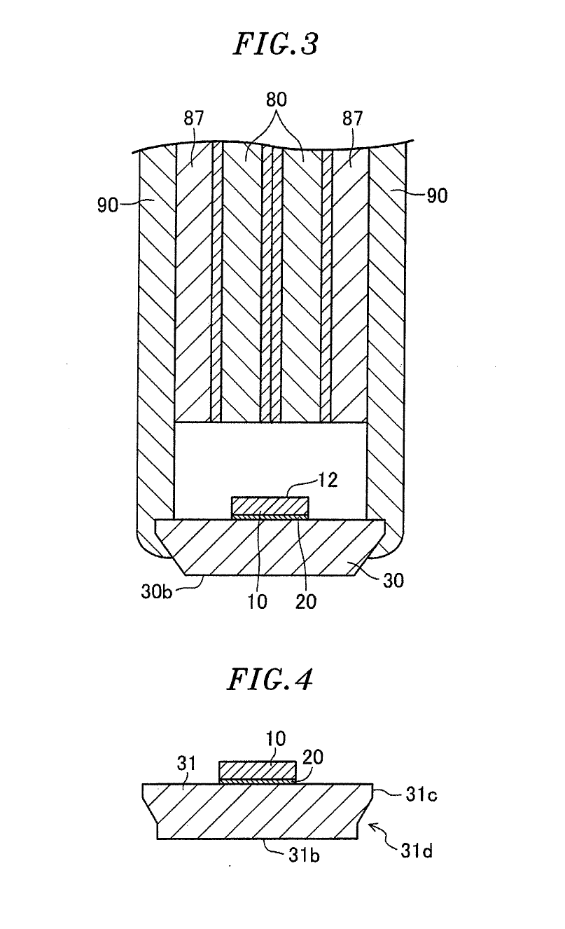

As shown in FIGS. 1A and 1B, a temperature sensor according to a first embodiment includes a member configured by fixedly securing a sensing member 10 to a retention surface 30a of a retention member 30 by an adhesive 20. As shown in FIGS. 2A to 3, this member is fitted into and secured to a tip of a cylindrical sleeve 90. A non-retention surface 30b of the retention member 30 opposite to the retention surface 30a to which the sensing member 10 is secured is exposed to the outside from the sleeve 90. A plurality of optical fibers 80 surrounded by a cover 87 is inserted into the sleeve 90.

The sensing member 10 of the present embodiment may be made of a semiconductor (e.g., GaAs, GaP, Si or the like) having temperature-dependent optical absorption edge and temperature-dependent light transmission spectrum, a semiconductor (e.g., GaAs crystal in form of heterostructures surrounded by a cap layer of AlₓGa₁₋ₓAs or the like) whose fluorescence wavelength is shifted depending on a temperature, or a phosphor having temperature-dependent fluorescence lifetime. The sensing member 10 is a plate-shaped member and has a surface (first surface) 12 facing the optical fibers 80.

In the temperature sensor of the present embodiment, light is irradiated from one of the optical fibers 80 to the sensing member 10 and reflected by a second surface opposite to the first surface 12 of the sensing member 10. The reflected light enters another optical fiber 80.

The retention member 30 of the present embodiment is a circular plate-shaped member. A cut-out portion 30d is formed by slantingly cutting a peripheral portion of the non-retention surface 30b toward the side surface 30c. The cut-out portion 30d is formed by cutting the peripheral portion of the non-retention surface 30b and the side surface 30c and has a tapered shape that becomes thinner toward the non-retention surface 30b.

In the present embodiment, the retention member 30 to which the sensing member 10 is secured is mounted on a stepped portion 90a formed at the tip of the sleeve 90 made of super engineering plastic and, then, a tip portion 90b of the sleeve 90 is heated to bend and come into contact with the cut-out portion 30d, as shown in FIGS. 2A and 2B. As a consequence, the tip of the sleeve 90 is engaged with and secured to the cut-out portion 30d. Since the tip of the sleeve 90 is deformed by heat, the retention member 30 can be reliably secured within a short period of time, which makes it possible to reduce variation of the respective temperature sensors in a securing strength, a securing position, an inclination of the non-retention surface 30b or the like. As a result, the manufacturing cost can be reduced and the variation of the respective temperature sensors in the strength or the temperature characteristics can be reduced.

In the present embodiment, it is preferable that the retention member 30 and the sleeve 90 have a high mechanical strength and a high heat resistance; the retention member 30 has a high thermal conductivity; the sleeve 90 has a low thermal conductivity; and a difference in linear expansion coefficients between the retention member 30 and the sleeve 90 is small. For example, the retention member 30 is preferably made of copper or aluminum in view of cost. The sleeve 90 is preferably made of polyethersulfone (PES), polyphenylenesulfide (PPS), polyetheretherketone (PEEK) or the like in view of melting point or cost. Especially, in the case of using the retention member 30 made of pure aluminum and the sleeve 90 made of PPS, the linear expansion coefficients therebetween (pure aluminum: 25×10⁻⁶/° C., PPS: 26×10⁻⁶/° C.) are substantially the same and, thus, engagement failure caused by temperature change is avoided.

### Second Embodiment

FIGS. 4 and 5 show main parts of a temperature sensor according to a second embodiment. The temperature sensor of the second embodiment have the same material, configuration and shape as those of the temperature sensor of the first embodiment except that a shape of a cut-out portion 31d of a retention member 31 is different from that in the first embodiment.

The cut-out portion 31d of the present embodiment is formed by cutting a peripheral portion of a non-retention surface 31b of the retention member 31 in a direction perpendicular to the non-retention surface 31b and subsequently in a direction inclined toward the side surface 31c. In the present embodiment, an area of the non-retention surface 31b is greater than that in the first embodiment and, thus, the contact area with the temperature measurement target is increased. Accordingly, the temperature responsiveness is further improved in addition to the effect of the first embodiment.

### Third Embodiment

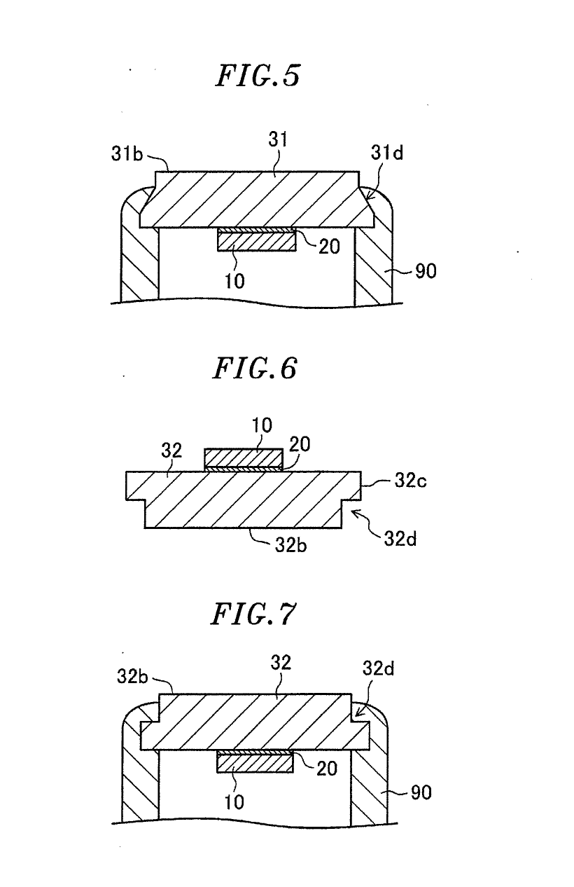

FIGS. 6 and 7 show main parts of a temperature sensor according to a third embodiment. The temperature sensor of the third embodiment have the same material, configuration and shape as those of the temperature sensor of the first embodiment except that a shape of a cut-out portion 32d of a retention member 32 is different from that in the first embodiment.

The cut-out portion 32d of the present embodiment is a stepped portion formed by cutting a peripheral portion of a non-retention surface 32b of the retention member 32 in a direction perpendicular to the non-retention surface 32b and subsequently in a direction parallel to the non-retention surface 32b toward the side surface 32c. In the present embodiment, an area of the non-retention surface 32b is greater than that in the first embodiment and, thus, the contact area with the temperature measurement target is increased. Accordingly, the temperature responsiveness is further improved in addition to the effect of the first embodiment.

### Fourth Embodiment

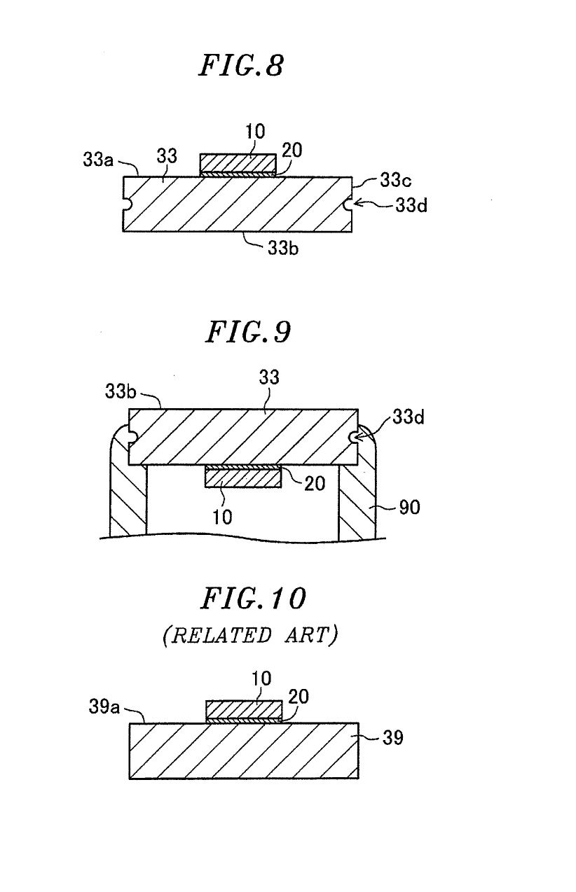

FIGS. 8 and 9 show main parts of a temperature sensor according to a fourth embodiment. The temperature sensor of the fourth embodiment have the same material, configuration and shape as those of the first embodiment except that a shape of a cut-out portion 33d of a retention member 33 is different from that in the first embodiment.

The cut-out portion 33d of the present embodiment is a recess (groove) circumferentially formed on the side surface 33c between a retention surface 33a and a non-retention surface 33b of the retention member 33. In the present embodiment, an area of the non-retention surface 33b is greater than that in the first embodiment and, thus, the contact area with the temperature measurement target is increased. Accordingly, the temperature responsiveness is further improved in addition to the effect of the first embodiment.

### Fifth Embodiment

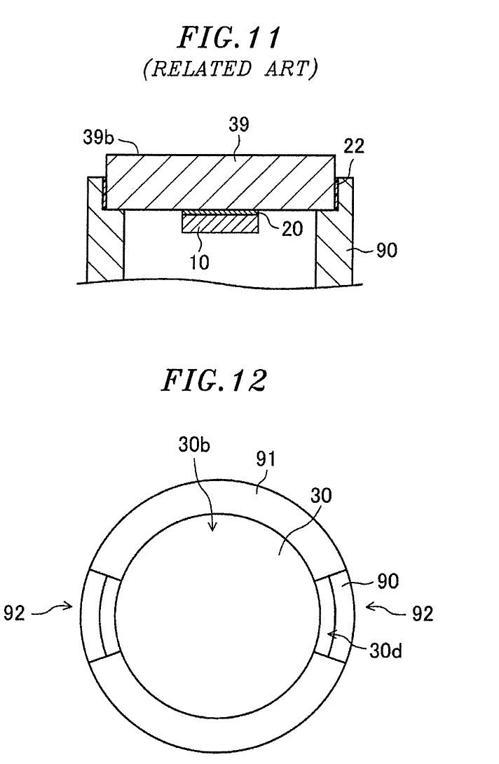

FIG. 12 shows a leading end portion of a temperature sensor according to a fifth embodiment. The temperature sensor of the fifth embodiment have the same material, configuration and shape as those of the temperature sensor of the first embodiment except that cut-off portions 92 are formed at the tip of the sleeve 90.

In the present embodiment, the cut-off portions 92 are formed at two locations of the tip of the sleeve 90 by cutting two sections of an engagement portion 91 of the tip of the sleeve 90 to be engaged with the cut-out portion 30d of the retention member 30. The cut-off portions 92 are formed before the sleeve 90 is engaged with the cut-out portion 30d of the retention member 30. Therefore, when the retention member 30 is mounted on the tip of the sleeve 90 by tweezers or the like, the mounting operation can be quickly and accurately performed by positioning the tweezers or the like in the cut-off portions 92. Besides, the cut-off portions 92 allow communication between the inner space and the outside of the sleeve 90, so that condensation in the sleeve 90 can be suppressed. In the present embodiment, the effect of the first embodiment is also obtained. Further, in order to reliably transfer heat from the temperature measurement surface 30b to the sensing member 10, it is preferable to make a contact area between the retention member 30 and the sleeve 90 as small as possible. Thus, although it is not illustrated, it is possible to increase a width of the cut-off portions 92 or increase the number of the cut-off portions 92 to, e.g., three or four within a range in which the securing strength is maintained.

### Other Embodiments

The above-described embodiments are merely exemplary embodiments of the present invention. The present invention is not limited to the above embodiments and may be combined with or partially replaced by a well-known technique in the related art. A modified invention that is easily conceivable by those skilled in the art is also included in the present invention.

The sensing member may have a polygonal shape, a circular shape or the like, other than a quadrilateral shape. The retention member may have, e.g., a polygonal shape, an elliptic shape or the like, other than a circular shape. The sleeve may have a polygonal or an elliptic horizontal cross sectional shape in compliance with the shape of the retention member.

In the above embodiments, the optical fiber includes a plurality of fibers such as a fiber for guiding light irradiated to the sensing member and a fiber for guiding the light reflected from the sensing member. However, the optical fiber may be a single multicore fiber having a plurality of cores. Alternatively, the optical fiber may be a single fiber having both functions of guiding light and receiving light.

As described above, the temperature sensor of the present invention can be manufactured at a low cost without variation and effectively used as an optical temperature sensor which uses no electric current.

### EXPLANATION OF REFERENCE NUMERALS

10: sensing member
30: retention member
30b: non-retention surface
30c: side surface
30d: cut-out portion
31: retention member
31b: non-retention surface
31c: side surface
31d: cut-out portion
32: retention member
32b: non-retention surface
32c: side surface
32d: cut-out portion
33: retention member
33b: non-retention surface
33c: side surface
33d: cut-out portion
80: optical fiber
90: sleeve
92: cut-off portion

1. A temperature sensor comprising:
a sensing member;
a retention member configured to fixedly secure the sensing member;
an optical fiber configured to irradiate the sensing member with light and guide the light reflected from the sensing member; and
a cylindrical sleeve configured to accommodate the optical fiber,
wherein the retention member is a plate-shaped component and has a cut-out portion formed on at least one of a peripheral portion of a non-retention surface of the retention member opposite to a retention surface of the retention member to which the sensing member is fixedly secured and a side surface of the retention member,
the retention member is secured to a tip of the sleeve so that the non-retention surface is exposed to an outside, and
the tip of the sleeve is engaged with the cut-out portion.

2. The temperature sensor of claim 1, wherein the retention member is made of a metal and the sleeve is made of super engineering plastic.

3. The temperature sensor of claim 2, wherein the retention member is made of aluminum and the sleeve is made of polyphenylene sulfide.

4. The temperature sensor of claim 1, wherein a cut-off portion that allows communication between an inner space and an outer space of the sleeve is formed at the tip of the sleeve.

5. The temperature sensor of claim 2, wherein a cut-off portion that allows communication between an inner space and an outer space of the sleeve is formed at the tip of the sleeve.

6. The temperature sensor of claim 3, wherein a cut-off portion that allows communication between an inner space and an outer space of the sleeve is formed at the tip of the sleeve.
